(19) United States
(12) Patent Application Publication
(10) Pub. No.: US 2023/0135794 A1
(43) Pub. Date: May 4, 2023

(54) SYNCHRONIZING ITEM RECOMMENDATIONS ACROSS APPLICATIONS USING MACHINE LEARNING

(71) Applicant: International Business Machines Corporation, Armonk, NY (US)

(72) Inventors: Fei Qi, Xian (CN); Zhen Ou Yun, Xian (CN); Qing Li, Beijing (CN); Shan Gao, Beijing (CN); Lei Lei Hu, Xian (CN); Xiao Kou, Xian (CN); Xiao Ping Liu, Xian (CN); Tian Jiao Pu, Xian (CN)

(21) Appl. No.: 17/452,732

(22) Filed: Oct. 28, 2021

(51) Int. Cl. G06Q 30/06; G06N 20/00

(52) U.S. Cl. CPC G06Q 30/0631; G06N 20/00; G06Q 30/0633

(57) ABSTRACT

A computer provides item recommendations for transactions. The computer receives a request to conduct a first transaction by a user and receives a first list of items and associated First List Item Metadata “FLIM”. The computer applies a first application ranking methodology to the FLIM and presents an Arranged First List of Items to the user. After completing the transaction, the computer identifies an Updated First List Item “UFLI” having a Predetermined Metadata Changing Condition. The computer identifies, items similar to the UFLI and revises the corpus metadata by applying a correction action to the UFLI and similar items. The computer receives a request to conduct a second transaction by a user and receives a second list of items and Second List Item Metadata “SLIM”. The computer applies a second application ranking methodology to the SLIM and presents an Arranged Second List of Items to the user.

### BACKGROUND

The present invention relates generally to the field of transaction choice generation, and more specifically, to automatically synchronizing recommended choices across multiple applications.

With the development of the Internet and the increased availability of data, computer users have moved into an era of information overload. Recommendation systems have been developed to help users conduct data-intensive transactions. These systems assist users by providing information deemed relevant to the user for a particular transaction. As the number options available for users to conduct online transactions increases, recommendation systems that streamline the online transaction process are increasing in value.

### SUMMARY

According to one embodiment, a computer-implemented method for providing item recommendations for transactions includes, in response to receiving, by a computer, a request to conduct a first transaction by a user with a first application available to the computer, receiving from a corpus of item metadata, a first list of items and associated First List Item Metadata “FLIM”. The computer presents to the user an Arranged First List of Items “AFLIs” generated by the computer applying a first application ranking methodology to the FLIM. The computer in response to completion of the first transaction, identifying an Updated First List Item “UFLI” having a Predetermined Metadata Changing Condition “PMCC”. The computer identifies within the AFLIs, by the computer using a Machine Learning Similarity Assessment Model, a set of Adjustment Candidate Items “ACIs” similar to the UFLI. The computer generates a revised corpus of item metadata by the computer applying a correction action to the UFLI and ACIs within the corpus of item metadata. The computer, in response to receiving, by a computer, a request to conduct a second transaction by a user with a second application available to the computer, receiving from a corpus of item metadata, a second list of items and associated Second List Item Metadata “SLIM”. The computer arranges a second the second list of items, at least in part, by applying a second application ranking methodology to the SLIM and presenting an Arranged Second List of Items “ASLIs” to the user. According to aspects of the invention, the Machine Learning Similarity Assessment Model is selected from the group consisting of such as a Support Vector Machine “SVM”, a cosine similarity assessment, a Tanimoto index, Pearson correlation coefficient. According to aspects of the invention, at least one of the first application ranking methodology arrangement and the second application ranking methodology arrangement is based on assessing a similarity of an item feature vector to a target reference vector associated with a relevant at least one of the first application or second application. According to aspects of the invention, the corrective action is assigning a revised corpus rank to the Adjustment Candidate Items and the Updated First List Item. According to aspects of the invention, the corrective action is removing the Adjustment Candidate Items and the Updated First List Item from the corpus 106 when an applied Machine Learning (ML) model available to the computer trained to identify item rank drop trends indicates an associated item rank trend below a low performance threshold. According to aspects of the invention, the corrective action is removing the Adjustment Candidate Items and the Updated First List Item from the corpus 106 when an applied Machine Learning (ML) model available to the computer trained to identify stale items indicates that an associated item has been recommended and not selected for a quantity of transaction cycles exceeding a dormancy threshold. According to aspects of the invention, at least one of the first and second xactions is related to a commerce domain and wherein the metadata indicates an item popularity associated with the user.

According to another embodiment, a system to provide item recommendations for transactions includes a computer system comprising a computer readable storage medium having program instructions embodied therewith, the program instructions executable by a computer to cause the computer to: responsive to receiving a request to conduct a first transaction by a user with a first application available to the computer, receiving from a corpus of item metadata, a first list of items and associated First List Item Metadata “FLIM”; present to the user an Arranged First List of Items “AFLIs” generated by the computer applying a first application ranking methodology to the FLIM; responsive to completion of the first transaction, identify an Updated First List Item “UFLI” having a Predetermined Metadata Changing Condition “PMCC”; identify within the AFLIs, using a Machine Learning Similarity Assessment Model, a set of Adjustment Candidate Items “ACIs” similar to the UFLI; generate a revised corpus of item metadata by applying a correction action to the UFLI and ACIs within the corpus of item metadata; responsive to receiving a request to conduct a second transaction by a user with a second application available to the computer, receive from a corpus of item metadata, a second list of items and associated Second List Item Metadata “SLIM”; and arrange the second list of items, at least in part, by applying a second application ranking methodology to the SLIM and presenting an Arranged Second List of Items “ASLIs” to the user.

According to another embodiment, a computer program product to provide item recommendations for transactions, the computer program product comprising a computer readable storage medium having program instructions embodied therewith, the program instructions executable by a computer to cause the computer to: responsive to receiving a request to conduct a first transaction by a user with a first application available to the computer, receiving, using the computer, from a corpus of item metadata, a first list of items and associated First List Item Metadata “FLIM”; present, using the computer, to the user an Arranged First List of Items “AFLIs” generated by the computer applying a first application ranking methodology to the FLIM; responsive to completion of the first transaction, identify, using the computer, an Updated First List Item “UFLI” having a Predetermined Metadata Changing Condition “PMCC”; identify, using the computer, within the AFLIs using a Machine Learning Similarity Assessment Model, a set of Adjustment Candidate Items “ACIs” similar to the UFLI; generate, using the computer, a revised corpus of item metadata by applying a correction action to the UFLI and ACIs within the corpus of item metadata; responsive to receiving a request to conduct a second transaction by a user with a second application available to the computer, receive, using the computer, from a corpus of item metadata, a second list of items and associated Second List Item Metadata “SLIM”; and arrange, using the computer, the second list of items, at least in part, by applying a second application ranking methodology to the SLIM and presenting an Arranged Second List of Items “ASLIs” to the user.

The present disclosure recognizes and addresses the shortcomings and problems associated with cross-application recommendation optimization (e.g., coordinating recommendations made among various online transactions).

Aspects of the invention provide a streamlined user transaction experience across multiple applications by sorting, storing, and sharing recommendation data (e.g., including item preferences or satisfaction rates) generated within applications and shared among relevant applications.

Aspects of the invention distribute item metadata generated within one application into other applications for which the metadata is relevant (e.g., among several applications with which a user is working).

Aspects of the invention provide a recommender system that automatically provides lists of items recommended for users filtered by transaction type and arranged by a transaction-based ranking.

According to aspects of the invention, recommendations generated for a user vary across transaction type.

Aspects of the invention provide item recommendations across multiple applications and multiple transaction types.

Aspects of the invention provide real-time item recommendations.

Aspects of the invention synchronize item recommendation in a real-time manner with a shared data corpus to promote recommendation accuracy and consistency.

Aspects of the invention transfer item preference metadata between various applications and a corpus of shared item metadata.

Aspects of the invention monitor changes to a shared item metadata corpus and update transaction recommendations in a real-time manner.

Aspects of the invention monitor changes to recommend item metadata generated during user transactions.

Aspects of the invention monitor changes to recommend item metadata and use machine learning models to extends noted changes to similar recommended items (e.g., items noted by cosine similarity or other models selected by those skilled in this field to be meet a similarity threshold).

Aspects of the invention promote consistent item recommendation across multiple applications and accommodates near-real-time data access requests from monitored applications.

Aspects of the invention respond to simultaneous item recommendation requests in accordance with a determined degree of relevance between the requested data and the relevant transaction.

Aspects of the invention promote cross-application use of item recommendation updates made within various applications.

Aspects of the invention accommodate application specific recommendation models (e.g., item preference and rating policies related to frequency of item selection, time between incidents of item selection, etc.) with overall system recommendation models to generate coordinated recommendations across multiple applications.

Aspects of the invention provide a cross-application recommendation optimization system that stores, accesses, filters and sorts recommendation metadata from different applications. According to aspects of the invention, item metadata is associated with a relevant item (e.g., by an item tag, etc.). Aspects of the invention distribute shared metadata among relevant applications using associated Application Programming Interfaces “APIs” known for the various applications.

Aspects of the invention provide improved storage in a cross-application recommendation optimization system by using “key:value” pairs to store the item recommendation metadata locally, providing redundant metadata storage useful if a power outage occurs before shared corpus synchronization occurs.

Aspects of the invention provide improved data access in a cross-application recommendation optimization system by using a common interface available to connected application on this device can access this interface. According to aspects of the invention, the common interface supports consistent actions for each application (e.g., including data queries, in which specific recommendation data is received; data retrieval, in which item data may be received from a shared corpus and stored locally within an associated application environment; data uploading, in which locally-stored item data may be transferred to a shared corpus; data deletion, in which selected items are removed from current consideration; and scope adjustment, in which data item and application relevance are established.

Aspects of the invention provide improved data filtering in a cross-application recommendation optimization system by using application-based rating thresholds to make (and remove) item recommendations, based item metadata values. According to aspects of the invention, items with relevant metadata below application thresholds are removed from current recommendations.

Aspects of the invention provide improved data filtering in a cross-application recommendation optimization system by arranging items having sufficient item metadata values into updated groups after filtered items have been removed. According to aspects of the invention, items removed in accordance with application-specific rating policies may be removed from the shared corpus of considered items.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. The drawings are set forth as below as:

FIG. 1 is a schematic block diagram illustrating an overview of a system for computer-implemented generation and synchronization of item recommendations among several computer applications according to embodiments of the present invention.

FIG. 2 is a flowchart illustrating a method, implemented using the system shown in FIG. 1, of automatically generating and synchronizing item recommendations among several computer applications according to embodiments of the present invention.

FIG. 3 is a block showing selected aspects of a method, implemented using the method shown in FIG. 2, of automatically generating and synchronizing item recommendations among several computer applications according to embodiments of the present invention.

FIG. 4A is a table schematically representing aspects of a corpus of recommendation item metadata for use in the method shown in FIG. 2, of automatically generating and synchronizing item recommendations among several computer applications according to embodiments of the present invention.

FIG. 4B is a table schematically representing aspects of recommendation item metadata selected for use in a first transaction of the method shown in FIG. 2, of automatically generating and synchronizing item recommendations among several computer applications according to embodiments of the present invention.

FIG. 4C is a schematic representation of aspects of a user interface showing recommended items before use in a first transaction of the method shown in FIG. 2, of automatically generating and synchronizing item recommendations among several computer applications according to embodiments of the present invention.

FIG. 5A is a schematic representation of aspects of a user interface showing recommended items after use in a first transaction of the method shown in FIG. 2, of automatically generating and synchronizing item recommendations among several computer applications according to embodiments of the present invention.

FIG. 5B is a table schematically representing aspects of recommendation item metadata after use in a first transaction of the method shown in FIG. 2, of automatically generating and synchronizing item recommendations among several computer applications according to embodiments of the present invention.

FIG. 5C is a table schematically representing aspects of recommendation item metadata after use in a first transaction of the method shown in FIG. 2, of automatically generating and synchronizing item recommendations among several computer applications according to embodiments of the present invention.

FIG. 6A is a table schematically representing aspects of a corpus of recommendation item metadata updated after a first transaction of the method shown in FIG. 2, of automatically generating and synchronizing item recommendations among several computer applications according to embodiments of the present invention.

FIG. 6B is a table schematically representing aspects of recommendation item metadata selected for use in a second transaction of the method shown in FIG. 2, of automatically generating and synchronizing item recommendations among several computer applications according to embodiments of the present invention.

FIG. 6C is a schematic representation of aspects of a user interface showing recommended items before use in a second transaction of the method shown in FIG. 2, of automatically generating and synchronizing item recommendations among several computer applications according to embodiments of the present invention.

FIG. 7 is a schematic representation of item filtering aspects of the method shown in FIG. 2, of automatically generating and synchronizing item recommendations among several computer applications according to embodiments of the present invention.

FIG. 8 is a schematic block diagram depicting a computer system according to an embodiment of the disclosure which may be incorporated, all or in part, in one or more computers or devices shown in FIG. 1, and cooperates with the systems and methods shown in FIG. 1.

FIG. 9 depicts a cloud computing environment according to an embodiment of the present invention.

FIG. 10 depicts abstraction model layers according to an embodiment of the present invention.

### DETAILED DESCRIPTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a participant” includes reference to one or more of such participants unless the context clearly dictates otherwise.

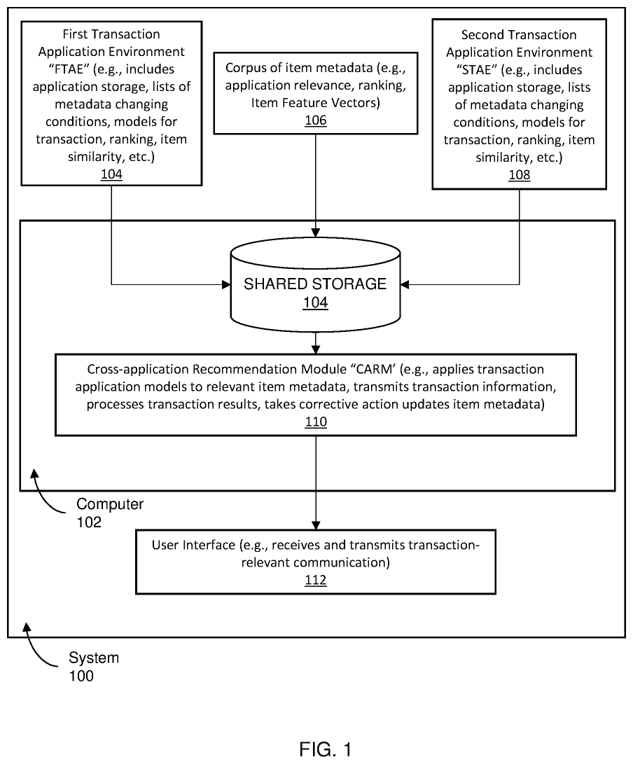

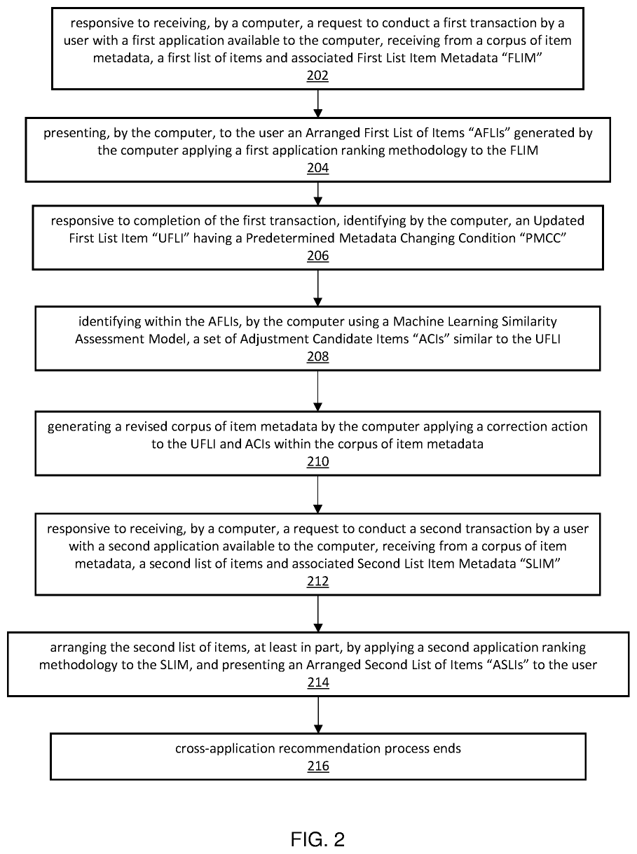

Now with combined reference to the Figures generally and with particular reference to FIG. 1 and FIG. 2, an overview of a method for automatically generating and synchronizing item recommendations among several computer applications usable within a system 100 as carried out by a server computer 102 having optionally shared storage 104.

The server computer 102 is in operative communication with a First Transaction Application Environment “FTAE” 104. According to aspects of the invention, the FTAE 104 includes application storage, lists of metadata changing conditions associated with a given computer application, models for conducting an application-relevant first transaction, models for ranking and arranging recommended items for the associated transaction, models for assessing item similarity, etc.).

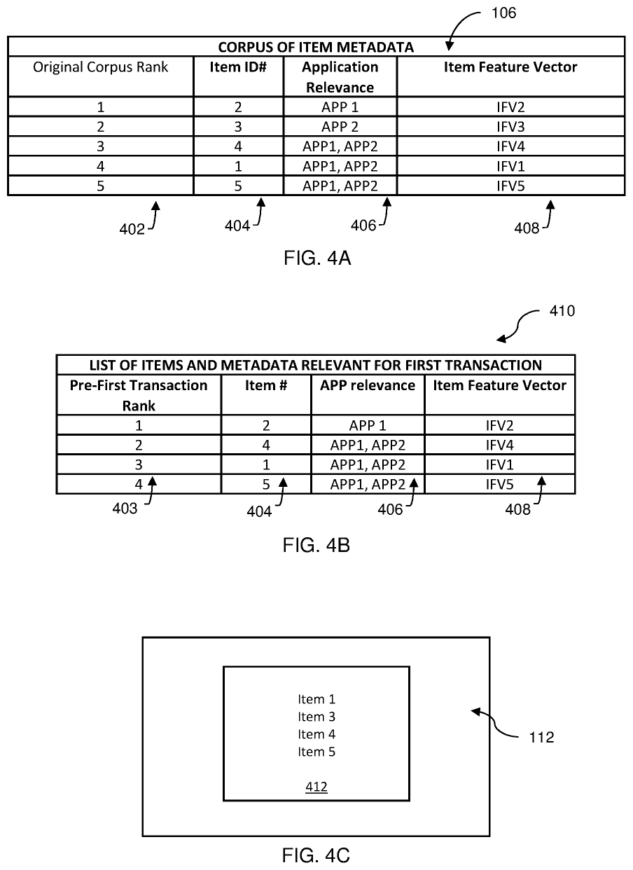

The server computer 102 is in operative communication with a corpus of item metadata 106. According to aspects of the invention, the corpus of item metadata 106 (e.g., as shown schematically in FIG. 4A) includes, with continued reference to FIG. 4A, item corpus ranking information 402 (e.g., an indication of overall item importance to a user across relevant applications), item identification indicia 404 (e.g., an ID to track the item through various processing steps), item application relevance 406 (e.g., an indication of applications for which a given item is relevant), and Item Feature Vectors “IFVs” 408 (e.g., a feature embedding associated with the item useful for comparison by Machine Learning (ML) models available to the server computer 102). It is noted that although the IFVs 408 may be provided directly within the corpus 106, they may also be generated by item feature vector models, and may also be generated for each item 404 via embedding generation methods selected by one skilled in this field.

The server computer 102 is in operative communication with a Second Transaction Application Environment “STAE” 108. According to aspects of the invention, the STAE 108 includes application storage, lists of metadata changing conditions associated with a given computer application, models for conducting an application-relevant second transaction, models for ranking and arranging recommended items for the associated transaction, models for assessing item similarity, etc.).

The server computer 102 includes Cross-Application Recommendation Module “CARM” 110 described more fully below. According to aspects of the invention, the CARM 110 identifies relevant items for various transactions 104, 108. According to aspects of the invention, the CARM 110 receives item information 402, 404, 406, 408 from the metadata corpus 106. According to aspects of the invention, the CARM 110 applies transaction application models to item metadata from the metadata corpus 106. According to aspects of the invention, the CARM 110 transmits transaction information, processes transaction results, and takes predetermined corrective actions based on metadata changes.

The server computer 102 is in operative connection with user interface 112. According to aspects of the invention, user interface 112 receives and transmits transaction-relevant communication (e.g., provides relevant item recommendations for various transactions 104, 106, accepts user selections from among recommended items, etc.).

Now with specific reference to FIG. 2, and to other figures generally, a computer-implemented method for automatically generating and synchronizing item recommendations among several computer applications using the system 100 described above will be discussed in detail.

The server computer 102 at block 202 in response to receiving a request to conduct a first transaction 104 by a user with a first application available to the computer, receives from a corpus of item metadata 106, a first list of items and associated First List Item Metadata “FLIM” 410 (e.g., as shown schematically in FIG. 4B).

The server computer 102 at block 204 via Cross-Application Recommendation Module “CARM” 110 presents to the user (e.g., via user interface 112, as shown schematically in FIG. 4C) an Arranged First List of Items “AFLIs” 412 generated by the server computer 102 applying a first application ranking methodology to the FLIM 410. According to aspects of the invention, the ranking methodology includes assessing similarity of one or more Item Feature Vectors 408 (e.g., via a cosine similarity evaluation method or other embodiment vector comparison methodology know to one of skill in this field) to target reference vectors associated with the first application 104 provided with the First Transaction Application Environments “FTAE”. According to aspects of the invention, the CARM 110 may use the item corpus rank 402 received from the metadata corpus 106 to establish a pre-first transaction rank 403 order for the AFLIs 412.

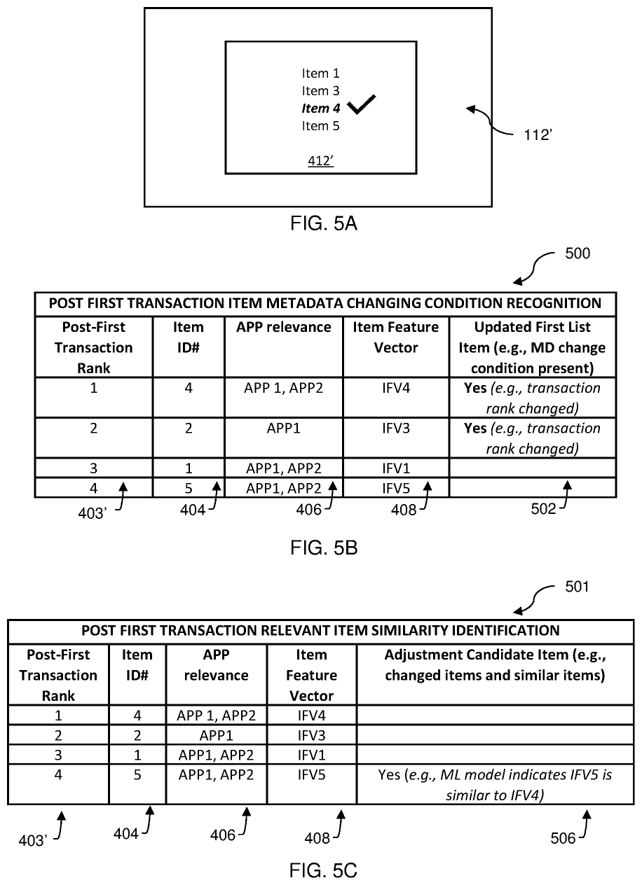

According to aspects of the invention, a user selects (e.g., picks via user interface 112′, as shown schematically in FIG. 5A) one of the recommended items in the AFLI, and the selection is highlighted in the user interface 112′ (e.g., as shown schematically at 412′ in FIG. 4C). When the user selection is made, the server computer 102 notes that the first transaction has been completed. According to aspects of the invention, the ranking of the selected item is adjusted to a post-first transaction rank 403′ (e.g., as shown schematically in FIG. 5B) in accordance with a Machine Learning (ML) model provided with the FTAE 104 trained to re rank listed items 412′ based on selections made during the first transaction. According to aspects of the invention, the CARM 110 establishes a post-first transaction metadata table 500 including relevant metadata 404, 406, 408 and an indication 502 of items with metadata changed due to the first transaction.

In response to completion of the first transaction, the server computer 102 at block 206, via continued use of the Cross-Application Recommendation Module “CARM” 110, identifies one or more Updated First List Item “UFLI” having a Predetermined Metadata Changing Condition “PMCC”. In an embodiment, the PMCC includes a change in item rank, and the CARM 110 compares, for each item, a pre-first transaction rank 403 (e.g., item rank before a selection has been made) of the AFLI 412 to the associated post-first transaction rank 403′ and identifies changes as a Predetermined Metadata Changing Condition “PMCC”. Other PMCC criteria may be established in accordance with the judgment of one having skill in this field.

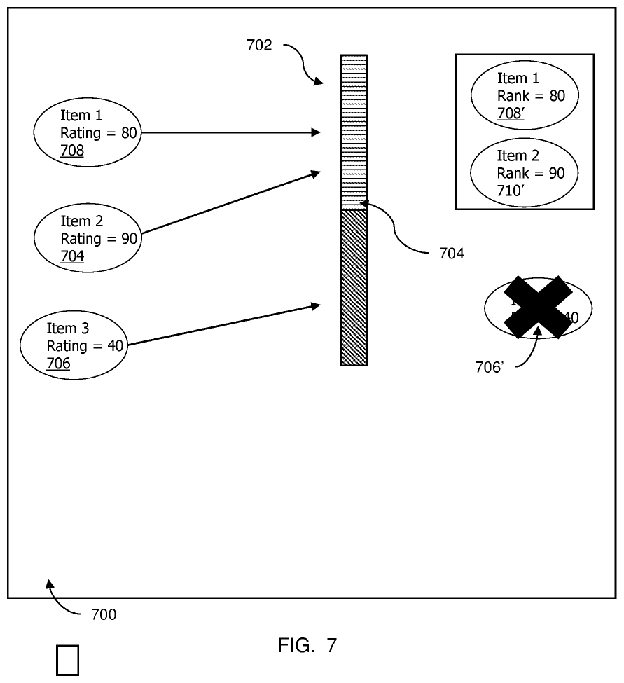

Aspects of the invention increase server computer 102 operation efficiency by initiating an item filtering routine 700 (e.g., as shown schematically in FIG. 7) to remove items having a rating value 702 calculated to be below a relevance threshold 704 when discovered at the conclusion of a transaction. In particular, the CARM 110 applies a Machine Learning (ML) model trained to attribute an item relevance (or relative importance) factor based on similarity of an Item Feature Vector “IFV” 408 to an IFV of a target item identified in Transaction Application Environments 104, 106. When the ML model determines that item IFV similarity rank compared to a target item IFV is below an “irrelevance threshold” 704 (e.g., a value of 60% similarity or below) the CARM 110 determines the item 706 is no longer relevant (e.g., as shown by item 706′) and is removed from further current consideration, thereby reducing wasted processing time otherwise needed to make further calculations that include the irrelevant item 706′. Efficiency is further increase when items 404 similar to (e.g., based a predetermined cosine similarity vale of 80% or other value selected by one of skill in this field) the irrelevant 706′ item are also dropped from further consideration. Evaluated items 708′, 710′ have ratings that exceed the relevance threshold and are passed along for further processing.

The server computer 102 at block 208, via continued use of the Cross-Application Recommendation Module “CARM” 110, identifying within the AFLIs, using a Machine Learning (ML) Similarity Assessment Model “SAM” (e.g., such as a Support Vector Machine “SVM”, a cosine similarity assessment, a Tanimoto index, Pearson correlation coefficient, or similar methodology known to one of skill in this field) applied to Item Feature Vectors 408, a set of Adjustment Candidate Items “ACIs” 506 to the UFLI 502. According to aspects of the invention, ACIs 506 are items that when compared to updated first list items 502 have similarity value that exceeds 85%, although similarity thresholds may be established by one of skill in this field.

The server computer 102 at block 210, via continued use of the Cross-Application Recommendation Module “CARM” 110 generates a revised corpus 106′ of item metadata by applying a correction action to the Updated First List Item UFLI (e.g., shown schematically at 502 in table 500 of FIG. 5B) and ACIs (e.g., shown schematically at 506 in table 501 of FIG. 5C) within table the corpus of item metadata.

In an embodiment, the CARM 110 removes, as a corrective action, items 404 from the revised corpus 106′ when an applied Machine Learning (ML) model trained to identify rank drop trends (e.g., items with multiple occurrences of rank lowering for a quantity of transaction cycles exceeding a “low performance threshold” such as 10 cycles out of 20 cycles, or another set of values selected by one of skill in this field) notes when the Updated First List Item or Adjustment Candidate Items have pre and post first transaction rank 403, 403′ comparisons that exceed the low performance threshold.

In an embodiment, the CARM 110 removes, as a corrective action, items 404 from the revised corpus 106′ when an applied Machine Learning (ML) model trained to identify stale (e.g., items with too many cycles of being recommended and not being selected) determines that an item 404 has been recommended and not selected for a quantity of transaction cycles exceeding a “dormancy threshold” (e.g., 5 cycles, or another value selected by one of skill in this field).

In an embodiment, the corrective action includes assigning a revised corpus rank 402′ to the items 404 in the corpus, based on items selected 412′ during the first transaction. In an embodiment, the CARM 110 applies a Machine Learning (ML) model trained to provide rank to transaction results in accordance with, at least in part, on an importance relevance factor attributed to the application responsible generating UFLIs and ACIs that are the basis for corpus re-ranking (e.g., the first application may be deemed very important and assigned an importance relevance factor of 1.5, and the first application may be deemed less important and assigned an importance relevance factor of 0.75). In an embodiment, the CARM 110 applies a Machine Learning (ML) model trained to provide rank to transaction results in accordance with, at least in part, on an importance relevance factor attributed to item feature vector associated with the UFLIs and ACIs that are the basis for corpus re-ranking. In an embodiment, the CARM 110 revises item corpus rank 402′ to reflect the difference between the pre-first transaction rank 403 and the post-first transaction rank 403′ multiplied by the first application importance relevance factor.

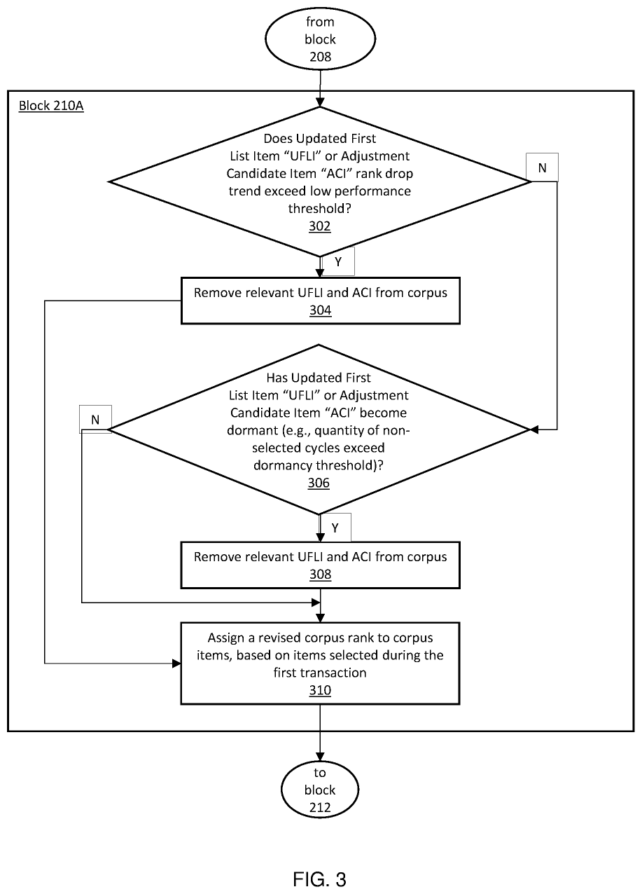

Now, with particular reference to FIG. 3, the CARM 110 corrective action processing flow is shown in detail (e.g., as shown schematically in block 210A). The CARM 110, at block 302 determines whether a rank drop trend for the Updated First List Item “UFLI” or an Adjustment Candidate Item “ACI” rank drop trend exceed low performance threshold. When the CARM 110 identifies that no rank drop trend is below the low performance threshold, flow continues to block 306. When the CARM 110 identifies a rank drop trend below the low performance threshold, flow moves to block 304 and the relevant UFLI and ACI are removed from the corpus 106′ and flow continues to block 310. The CARM 110, at block 306, determines whether an UFLI or ACI has become dormant (e.g., been recommended and not selected for a quantity of transaction cycles that exceeds the dormancy threshold). When the CARM 110 identifies that no UFLI or ACI is dormant, flow continues to block 310. When the CARM 110 identifies a dormant UFLI or ACI, flow continues to block 308, where the relevant UFLI and ACI are removed from the corpus 106′ and flow continues to block 310. The CARM 110 assigns, at block 310, a revised corpus rank 402′ to corpus items 404, based on items selected during the first transaction and flow continues to block 212.

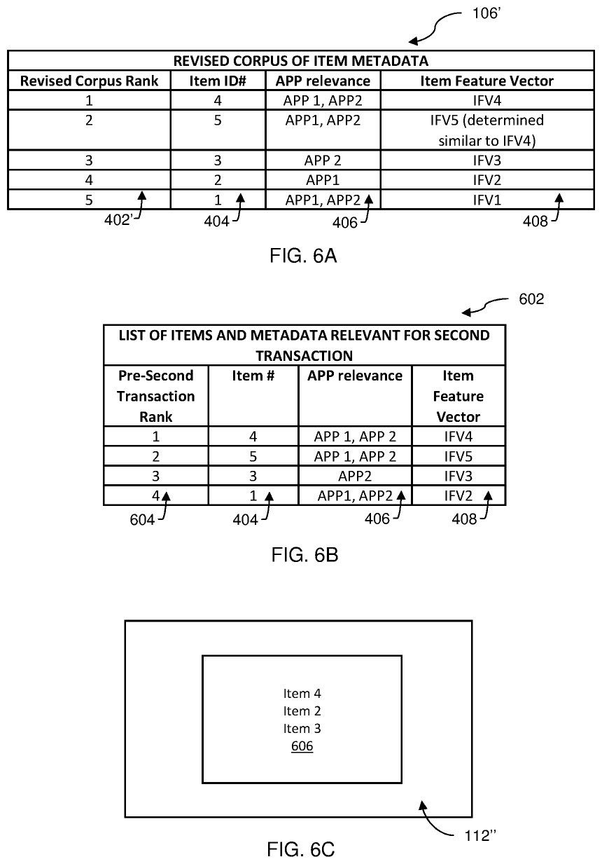

The server computer 102 at block 212 in response to receiving a request to conduct a second transaction 108 by a user with an application available to the computer, receives from a corpus of item metadata 106′, a second list of items and associated Second List Item Metadata “SLIM” 602 (e.g., as shown schematically in FIG. 6B).

The server computer 102 at block 214 via Cross-Application Recommendation Module “CARM” 110 presents to the user (e.g., via user interface 112″, as shown schematically in FIG. 6C) an Arranged Second List of Items “ASLIs” 606 generated by the server computer 102 applying a second application ranking methodology to the SLIM 602. According to aspects of the invention, the ranking methodology includes assessing similarity of one or more Item Feature Vectors 408 (e.g., via a cosine similarity evaluation method or other embodiment vector comparison methodology known to one of skill in this field) to target reference vectors associated with the second application 106 provided with the Second Transaction Application Environments “STAE”. According to aspects of the invention, the CARM 110 may use the item revised corpus rank 402′ received from the revised corpus of item metadata 106′ to establish a pre-second transaction rank 604 order for the ASLIs 606.

The cross-application recommendation process ends at block 214. It is noted that the first and second transactions 104, 108 may be selected from a variety of fields, however, aspects of the present invention are especially suited for making item recommendations 412, 612 in a shopping setting or other commerce-related domain. According to aspects of the invention, the items recommended 412, 612 are relevant to a user (e.g., indicate popularity with the user), across multiple transactions and among various (and additional) computer applications.

Regarding the flowcharts and block diagrams, the flowchart and block diagrams in the Figures of the present disclosure illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

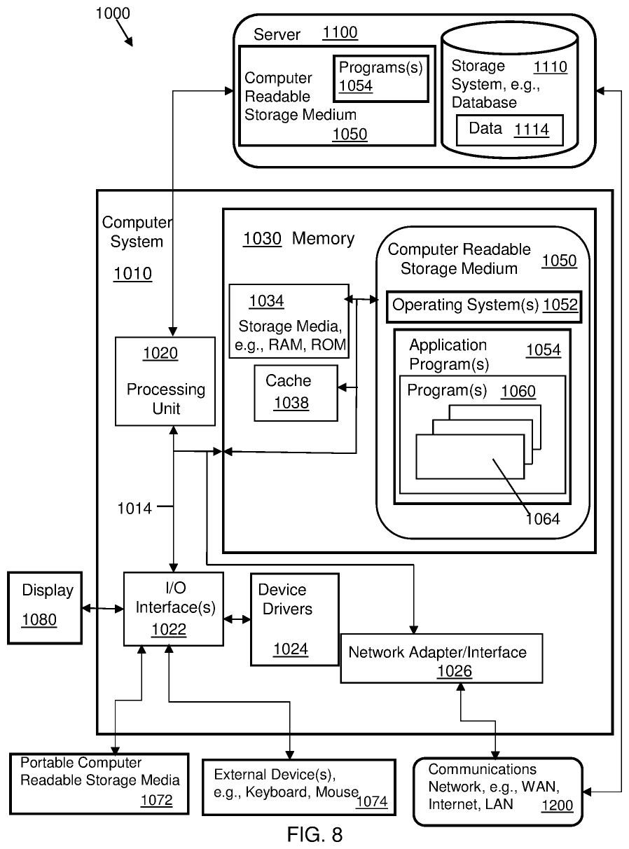

Referring to FIG. 8, a system or computer environment 1000 includes a computer diagram 1010 shown in the form of a generic computing device. The method of the invention, for example, may be embodied in a program 1060, including program instructions, embodied on a computer readable storage device, or computer readable storage medium, for example, generally referred to as memory 1030 and more specifically, computer readable storage medium 1050. Such memory and/or computer readable storage media includes non-volatile memory or non-volatile storage. For example, memory 1030 can include storage media 1034 such as RAM (Random Access Memory) or ROM (Read Only Memory), and cache memory 1038. The program 1060 is executable by the processor 1020 of the computer system 1010 (to execute program steps, code, or program code). Additional data storage may also be embodied as a database 1110 which includes data 1114. The computer system 1010 and the program 1060 are generic representations of a computer and program that may be local to a user, or provided as a remote service (for example, as a cloud based service), and may be provided in further examples, using a website accessible using the communications network 1200 (e.g., interacting with a network, the Internet, or cloud services). It is understood that the computer system 1010 also generically represents herein a computer device or a computer included in a device, such as a laptop or desktop computer, etc., or one or more servers, alone or as part of a datacenter. The computer system can include a network adapter/interface 1026, and an input/output (I/O) interface(s) 1022. The I/O interface 1022 allows for input and output of data with an external device 1074 that may be connected to the computer system. The network adapter/interface 1026 may provide communications between the computer system a network generically shown as the communications network 1200.

The computer 1010 may be described in the general context of computer system-executable instructions, such as program modules, being executed by a computer system. Generally, program modules may include routines, programs, objects, components, logic, data structures, and so on that perform particular tasks or implement particular abstract data types. The method steps and system components and techniques may be embodied in modules of the program 1060 for performing the tasks of each of the steps of the method and system. The modules are generically represented in the figure as program modules 1064. The program 1060 and program modules 1064 can execute specific steps, routines, sub-routines, instructions or code, of the program.

The method of the present disclosure can be run locally on a device such as a mobile device, or can be run a service, for instance, on the server 1100 which may be remote and can be accessed using the communications network 1200. The program or executable instructions may also be offered as a service by a provider. The computer 1010 may be practiced in a distributed cloud computing environment where tasks are performed by remote processing devices that are linked through a communications network 1200. In a distributed cloud computing environment, program modules may be located in both local and remote computer system storage media including memory storage devices.

The computer 1010 can include a variety of computer readable media. Such media may be any available media that is accessible by the computer 1010 (e.g., computer system, or server), and can include both volatile and non-volatile media, as well as removable and non-removable media. Computer memory 1030 can include additional computer readable media in the form of volatile memory, such as random access memory (RAM) 1034, and/or cache memory 1038. The computer 1010 may further include other removable/non-removable, volatile/non-volatile computer storage media, in one example, portable computer readable storage media 1072. In one embodiment, the computer readable storage medium 1050 can be provided for reading from and writing to a non-removable, non-volatile magnetic media. The computer readable storage medium 1050 can be embodied, for example, as a hard drive. Additional memory and data storage can be provided, for example, as the storage system 1110 (e.g., a database) for storing data 1114 and communicating with the processing unit 1020. The database can be stored on or be part of a server 1100. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1014 by one or more data media interfaces. As will be further depicted and described below, memory 1030 may include at least one program product which can include one or more program modules that are configured to carry out the functions of embodiments of the present invention.

The method(s) described in the present disclosure, for example, may be embodied in one or more computer programs, generically referred to as a program 1060 and can be stored in memory 1030 in the computer readable storage medium 1050. The program 1060 can include program modules 1064. The program modules 1064 can generally carry out functions and/or methodologies of embodiments of the invention as described herein. The one or more programs 1060 are stored in memory 1030 and are executable by the processing unit 1020. By way of example, the memory 1030 may store an operating system 1052, one or more application programs 1054, other program modules, and program data on the computer readable storage medium 1050. It is understood that the program 1060, and the operating system 1052 and the application program(s) 1054 stored on the computer readable storage medium 1050 are similarly executable by the processing unit 1020. It is also understood that the application 1054 and program(s) 1060 are shown generically, and can include all of, or be part of, one or more applications and program discussed in the present disclosure, or vice versa, that is, the application 1054 and program 1060 can be all or part of one or more applications or programs which are discussed in the present disclosure.

One or more programs can be stored in one or more computer readable storage media such that a program is embodied and/or encoded in a computer readable storage medium. In one example, the stored program can include program instructions for execution by a processor, or a computer system having a processor, to perform a method or cause the computer system to perform one or more functions.

The computer 1010 may also communicate with one or more external devices 1074 such as a keyboard, a pointing device, a display 1080, etc.; one or more devices that enable a user to interact with the computer 1010; and/or any devices (e.g., network card, modem, etc.) that enables the computer 1010 to communicate with one or more other computing devices. Such communication can occur via the Input/Output (I/O) interfaces 1022. Still yet, the computer 1010 can communicate with one or more networks 1200 such as a local area network (LAN), a general wide area network (WAN), and/or a public network (e.g., the Internet) via network adapter/interface 1026. As depicted, network adapter 1026 communicates with the other components of the computer 1010 via bus 1014. It should be understood that although not shown, other hardware and/or software components could be used in conjunction with the computer 1010. Examples, include, but are not limited to: microcode, device drivers 1024, redundant processing units, external disk drive arrays, RAID systems, tape drives, and data archival storage systems, etc.

It is understood that a computer or a program running on the computer 1010 may communicate with a server, embodied as the server 1100, via one or more communications networks, embodied as the communications network 1200. The communications network 1200 may include transmission media and network links which include, for example, wireless, wired, or optical fiber, and routers, firewalls, switches, and gateway computers. The communications network may include connections, such as wire, wireless communication links, or fiber optic cables. A communications network may represent a worldwide collection of networks and gateways, such as the Internet, that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. A network may also include a number of different types of networks, such as, for example, an intranet, a local area network (LAN), or a wide area network (WAN).

In one example, a computer can use a network which may access a website on the Web (World Wide Web) using the Internet. In one embodiment, a computer 1010, including a mobile device, can use a communications system or network 1200 which can include the Internet, or a public switched telephone network (PSTN) for example, a cellular network. The PSTN may include telephone lines, fiber optic cables, transmission links, cellular networks, and communications satellites. The Internet may facilitate numerous searching and texting techniques, for example, using a cell phone or laptop computer to send queries to search engines via text messages (SMS), Multimedia Messaging Service (MMS) (related to SMS), email, or a web browser. The search engine can retrieve search results, that is, links to websites, documents, or other downloadable data that correspond to the query, and similarly, provide the search results to the user via the device as, for example, a web page of search results.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

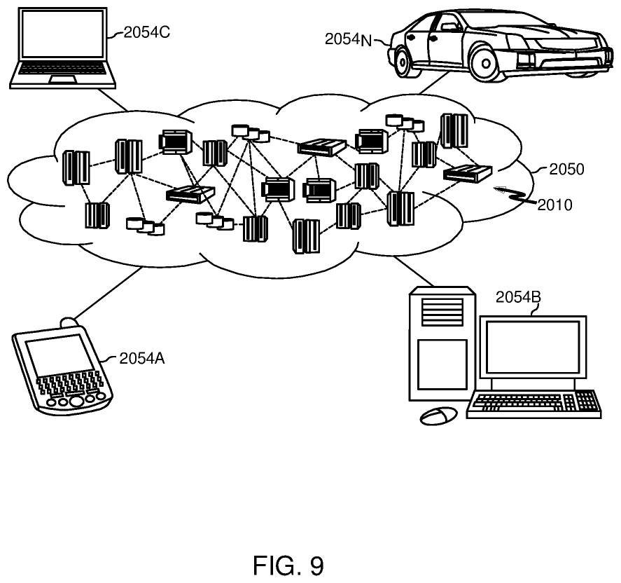

Referring now to FIG. 9, illustrative cloud computing environment 2050 is depicted. As shown, cloud computing environment 2050 includes one or more cloud computing nodes 2010 with which local computing devices used by cloud consumers, such as, for example, personal digital assistant (PDA) or cellular telephone 2054A, desktop computer 2054B, laptop computer 2054C, and/or automobile computer system 2054N may communicate. Nodes 2010 may communicate with one another. They may be grouped (not shown) physically or virtually, in one or more networks, such as Private, Community, Public, or Hybrid clouds as described hereinabove, or a combination thereof. This allows cloud computing environment 2050 to offer infrastructure, platforms and/or software as services for which a cloud consumer does not need to maintain resources on a local computing device. It is understood that the types of computing devices 2054A-N shown in FIG. 9 are intended to be illustrative only and that computing nodes 2010 and cloud computing environment 2050 can communicate with any type of computerized device over any type of network and/or network addressable connection (e.g., using a web browser).

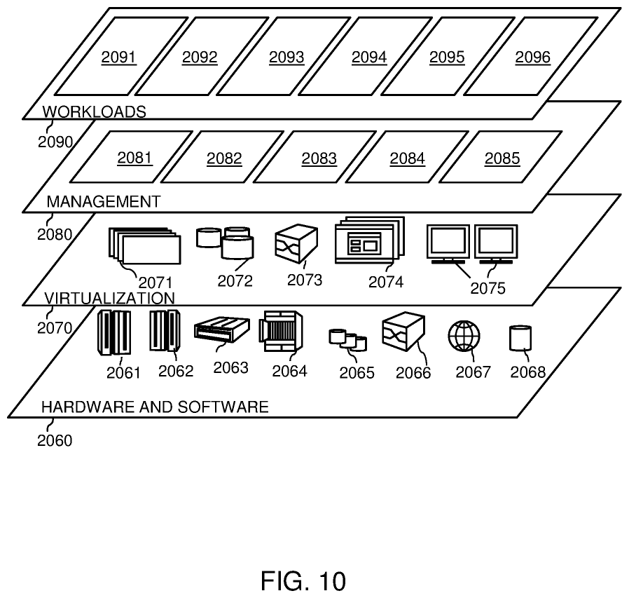

Referring now to FIG. 10, a set of functional abstraction layers provided by cloud computing environment 2050 (FIG. 9) is shown. It should be understood in advance that the components, layers, and functions shown in FIG. 10 are intended to be illustrative only and embodiments of the invention are not limited thereto. As depicted, the following layers and corresponding functions are provided:

Hardware and software layer 2060 includes hardware and software components. Examples of hardware components include: mainframes 2061; RISC (Reduced Instruction Set Computer) architecture based servers 2062; servers 2063; blade servers 2064; storage devices 2065; and networks and networking components 2066. In some embodiments, software components include network application server software 2067 and database software 2068.

Virtualization layer 2070 provides an abstraction layer from which the following examples of virtual entities may be provided: virtual servers 2071; virtual storage 2072; virtual networks 2073, including virtual private networks; virtual applications and operating systems 2074; and virtual clients 2075.

In one example, management layer 2080 may provide the functions described below. Resource provisioning 2081 provides dynamic procurement of computing resources and other resources that are utilized to perform tasks within the cloud computing environment. Metering and Pricing 2082 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 2083 provides access to the cloud computing environment for consumers and system administrators. Service level management 2084 provides cloud computing resource allocation and management such that required service levels are met. Service Level Agreement (SLA) planning and fulfillment 2085 provide pre-arrangement for, and procurement of, cloud computing resources for which a future requirement is anticipated in accordance with an SLA.

Workloads layer 2090 provides examples of functionality for which the cloud computing environment may be utilized. Examples of workloads and functions which may be provided from this layer include: mapping and navigation 2091; software development and lifecycle management 2092; virtual classroom education delivery 2093; data analytics processing 2094; transaction processing 2095; and automatically generating and synchronizing item recommendations among several computer applications 2096.

The descriptions of the various embodiments of the present invention have been presented for purposes of illustration, but are not intended to be exhaustive or limited to the embodiments disclosed. Likewise, examples of features or functionality of the embodiments of the disclosure described herein, whether used in the description of a particular embodiment, or listed as examples, are not intended to limit the embodiments of the disclosure described herein, or limit the disclosure to the examples described herein. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer implemented method of providing item recommendations for transactions, comprising:
responsive to receiving, by a computer, a request to conduct a first transaction by a user with a first application available to the computer, receiving from a corpus of item metadata, a first list of items and associated First List Item Metadata “FLIM”;
presenting, by the computer, to the user an Arranged First List of Items “AFLIs” generated by the computer applying a first application ranking methodology to the FLIM;
responsive to completion of the first transaction, identifying by the computer, an Updated First List Item “UFLI” having a Predetermined Metadata Changing Condition “PMCC”;
identifying within the AFLIs, by the computer using a Machine Learning Similarity Assessment Model, a set of Adjustment Candidate Items “ACIs” similar to the UFLI;
generating a revised corpus of item metadata by the computer applying a correction action to the UFLI and ACIs within the corpus of item metadata;
responsive to receiving, by a computer, a request to conduct a second transaction by a user with a second application available to the computer, receiving from a corpus of item metadata, a second list of items and associated Second List Item Metadata “SLIM”; and
arranging the second list of items, at least in part, by applying a second application ranking methodology to the SLIM and presenting an Arranged Second List of Items “ASLIs” to the user.

2. The method of claim 1, wherein the Machine Learning Similarity Assessment Model is selected from the group consisting of such as a Support Vector Machine “SVM”, a cosine similarity assessment, a Tanimoto index, Pearson correlation coefficient.

3. The method of claim 1, wherein at least one of the first application ranking methodology arrangement and the second application ranking methodology arrangement is based on assessing a similarity of an item feature vector to a target reference vector associated with a relevant at least one of the first application or second application.

4. The method of claim 1, wherein the corrective action is assigning a revised corpus rank to the Adjustment Candidate Items and the Updated First List Item.

5. The method of claim 1, wherein the corrective action is removing the Adjustment Candidate Items and the Updated First List Item from the corpus 106 when an applied Machine Learning (ML) model available to the computer trained to identify item rank drop trends indicates an associated item rank trend below a low performance threshold.

6. The method of claim 1, wherein the corrective action is removing the Adjustment Candidate Items and the Updated First List Item from the corpus 106 when an applied Machine Learning (ML) model available to the computer trained to identify stale items indicates that an associated item has been recommended and not selected for a quantity of transaction cycles exceeding a dormancy threshold.

7. The method of claim 1, wherein at least one of the first and second xactions is related to a commerce domain and wherein the metadata indicates an item popularity associated with the user.

8. A system to provide item recommendations for transactions, which comprises:
a computer system comprising a computer readable storage medium having program instructions embodied therewith, the program instructions executable by a computer to cause the computer to:
responsive to receiving a request to conduct a first transaction by a user with a first application available to the computer, receiving from a corpus of item metadata, a first list of items and associated First List Item Metadata “FLIM”;
present to the user an Arranged First List of Items “AFLIs” generated by the computer applying a first application ranking methodology to the FLIM;
responsive to completion of the first transaction, identify an Updated First List Item “UFLI” having a Predetermined Metadata Changing Condition “PMCC”;
identify within the AFLIs, using a Machine Learning Similarity Assessment Model, a set of Adjustment Candidate Items “ACIs” similar to the UFLI;
generate a revised corpus of item metadata by applying a correction action to the UFLI and ACIs within the corpus of item metadata;
responsive to receiving a request to conduct a second transaction by a user with a second application available to the computer, receive from a corpus of item metadata, a second list of items and associated Second List Item Metadata “SLIM”; and
arrange the second list of items, at least in part, by applying a second application ranking methodology to the SLIM and presenting an Arranged Second List of Items “ASLIs” to the user.

9. The system of claim 8, wherein the Machine Learning Similarity Assessment Model is selected from the group consisting of such as a Support Vector Machine “SVM”, a cosine similarity assessment, a Tanimoto index, Pearson correlation coefficient.

10. The system of claim 8, wherein at least one of the first application ranking methodology arrangement and the second application ranking methodology arrangement is based on assessing a similarity of an item feature vector to a target reference vector associated with a relevant at least one of the first application or second application.

11. The system of claim 8, wherein the corrective action is assigning a revised corpus rank to the Adjustment Candidate Items and the Updated First List Item.

12. The system of claim 8, wherein the corrective action is removing the Adjustment Candidate Items and the Updated First List Item from the corpus 106 when an applied Machine Learning (ML) model available to the computer trained to identify item rank drop trends indicates an associated item rank trend below a low performance threshold.

13. The system of claim 8, wherein the corrective action is removing the Adjustment Candidate Items and the Updated First List Item from the corpus 106 when an applied Machine Learning (ML) model available to the computer trained to identify stale items indicates that an associated item has been recommended and not selected for a quantity of transaction cycles exceeding a dormancy threshold.

14. The system of claim 8, wherein at least one of the first and second xactions is related to a commerce domain and wherein the metadata indicates an item popularity associated with the user.

15. A computer program product to provide item recommendations for transactions, the computer program product comprising a computer readable storage medium having program instructions embodied therewith, the program instructions executable by a computer to cause the computer to:
responsive to receiving a request to conduct a first transaction by a user with a first application available to the computer, receiving, using the computer, from a corpus of item metadata, a first list of items and associated First List Item Metadata “FLIM”;
present, using the computer, to the user an Arranged First List of Items “AFLIs” generated by the computer applying a first application ranking methodology to the FLIM;
responsive to completion of the first transaction, identify, using the computer, an Updated First List Item “UFLI” having a Predetermined Metadata Changing Condition “PMCC”;
identify, using the computer, within the AFLIs using a Machine Learning Similarity Assessment Model, a set of Adjustment Candidate Items “ACIs” similar to the UFLI;
generate, using the computer, a revised corpus of item metadata by applying a correction action to the UFLI and ACIs within the corpus of item metadata;
responsive to receiving a request to conduct a second transaction by a user with a second application available to the computer, receive, using the computer, from a corpus of item metadata, a second list of items and associated Second List Item Metadata “SLIM”; and
arrange, using the computer, the second list of items, at least in part, by applying a second application ranking methodology to the SLIM and presenting an Arranged Second List of Items “ASLIs” to the user.

16. The computer program product of claim 15, wherein the Machine Learning Similarity Assessment Model is selected from the group consisting of such as a Support Vector Machine “SVM”, a cosine similarity assessment, a Tanimoto index, Pearson correlation coefficient.

17. The computer program product of claim 15, wherein at least one of the first application ranking methodology arrangement and the second application ranking methodology arrangement is based on assessing a similarity of an item feature vector to a target reference vector associated with a relevant at least one of the first application or second application.

18. The computer program product of claim 15, wherein the corrective action is assigning a revised corpus rank to the Adjustment Candidate Items and the Updated First List Item.

19. The computer program product of claim 15, wherein the corrective action is removing the Adjustment Candidate Items and the Updated First List Item from the corpus 106 when an applied Machine Learning (ML) model available to the computer trained to identify item rank drop trends indicates an associated item rank trend below a low performance threshold.

20. The computer program product of claim 15, wherein the corrective action is removing the Adjustment Candidate Items and the Updated First List Item from the corpus 106 when an applied Machine Learning (ML) model available to the computer trained to identify stale items indicates that an associated item has been recommended and not selected for a quantity of transaction cycles exceeding a dormancy threshold.
